(19) United States
(12) Patent Application Publication
(10) Pub. No.: US 2015/0089632 A1
(43) Pub. Date: Mar. 26, 2015

(54) APPLICATION AUTHENTICATION CHECKING SYSTEM

(71) Applicants: Aaron Robert Bartholomew, Noel, MO (US); Michael Scott Hester, Bentonville, AR (US); Gerald Duane Corson, III, Rogers, AR (US); William Hogg, Rogers, AR (US)

(72) Inventors: Aaron Robert Bartholomew, Noel, MO (US); Michael Scott Hester, Bentonville, AR (US); Gerald Duane Corson, III, Rogers, AR (US); William Hogg, Rogers, AR (US)

(21) Appl. No.: 14/037,638

(22) Filed: Sep. 26, 2013

(51) Int. Cl. G06F 21/31

(52) U.S. Cl. CPC G06F 21/31
USPC 726/17

(57) ABSTRACT

A method for authentication checking comprises receiving an authentication verification request for accessing an application. The authentication verification request includes a user identification, a device identification and an application identification. A validity of the authentication verification request is determined based on at least a last known authentication information, and a first subset of an application policy rule-set specific to the user identification and the device identification, if the application policy rule-set permits cross-application authentication; otherwise the validity is determined based on at least a second subset of the application policy rule-set specific to the user identification, the device identification and the application identification. Access to the application is enabled if the validity of the authentication verification request is true; otherwise a new authentication is requested.

### FIELD OF THE INVENTION

The invention relates generally to authenticating a request to access an application. More specifically, the invention relates to efficiently authenticating requests across multiple applications, each potentially having different authentication requirements.

### BACKGROUND

Accessing an application on a device frequently requires a user to log into, or otherwise authenticate their credentials, to be allowed access to the application. Authentication is required when the application is first accessed and periodically thereafter. Authentication ensures a way of securing unauthorized access to the device and provides a method to track the most recent access by a user or potentially a device.

Various applications require different levels of authentication with different constraints. For example, different applications may have different time requirements regarding how often a user must re-authenticate. Existing single sign-on solutions do not address the need for different levels of authentication or efficiently manage authentication across multiple applications.

### BRIEF SUMMARY

In one aspect, the invention features a method for authentication checking comprising receiving an authentication verification request for accessing an application. The authentication verification request includes a user identification, a device identification and an application identification. A validity of the authentication verification request is determined based on at least a last known authentication information and a first subset of an application policy rule-set specific to the user identification and the device identification, if the policy rule-set permits cross-application authentication. The validity of the authentication verification request is determined based on at least the last known authentication information, and a second subset of the application policy rule-set specific to the user identification, the device identification and the application identification, if the application policy rule-set does not permit cross-application authentication. Access to the application is enabled if the validity of the authentication verification request is true. A new authentication is requested if the validity of the authentication verification request is false.

In another aspect, the invention features a method for accessing an application on a device comprising initiating an authentication verification request for accessing an application. The authentication verification request includes a user identification, a device identification and an application identification. The application is accessed if the user identification and the device identification are valid, a user authentication is valid and if the cross-application authentication is allowed. The application is accessed if the user identification and the device identification are valid for the application identified by the application identification, the user authentication is valid and if cross-application authentication is not allowed.

In another aspect, the invention features a computer program product for authentication checking. The computer program product comprises a non-transitory computer readable storage medium having computer readable program code embodied therewith. The computer readable program code comprises computer readable program code configured to receive an authentication verification request for accessing an application. The authentication verification request includes a user identification, a device identification and an application identification. Computer readable program code is configured to determine a validity of the authentication verification request, based on at least a last known authentication information, and a first subset of an application policy rule-set specific to the user identification and the device identification, if the application policy rule-set permits cross-application authentication. Computer readable program code is configured to determine the validity of the authentication verification request, based on at least the last known authentication information, and a second subset of the application policy rule-set specific to the user identification, the device identification and the application identification, if the application policy rule-set does not permit cross-application authentication. Computer readable program code is configured to enable access to the application if the validity of the authentication verification request is true. Computer readable program code is configured to request a new authentication if the validity of the authentication verification request is false.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a schematic view of an embodiment of an application authentication checking system.

FIG. 2 is a flowchart representation of the steps performed in a mobile device to perform application authentication checking.

FIG. 3 is a flowchart representation of the steps performed in an application authentication system to perform application authentication checking.

FIG. 4 is a schematic view of an Application Policy Rule-Set according to an embodiment of the present invention.

FIG. 5 is a schematic view of a Last Known Authentication Information according to an embodiment of the present invention.

### DETAILED DESCRIPTION

Embodiments of methods and systems described herein provide for the efficient authentication of credentials required to access one or more applications. A non-limiting example of credentials include identifying information for a user attempting to access an application, the device used to initiate the access and the device used to host the application. Each application that is accessed has a unique set of requirements dictating different levels of security.

In one example, an application to access a bank account requires more frequent authentication than a social media application. The same application used to access the bank account requires more frequent authentication on a mobile device than a desktop computer. In another embodiment, authentication performed for one application enables the same user and device to access another application of a similar category without requiring a new authentication. For example, access to two social media applications having similar security levels is enabled by authenticating access to just one of the two applications. In another example, access to two applications is enabled if each of the applications have a minimum security level.

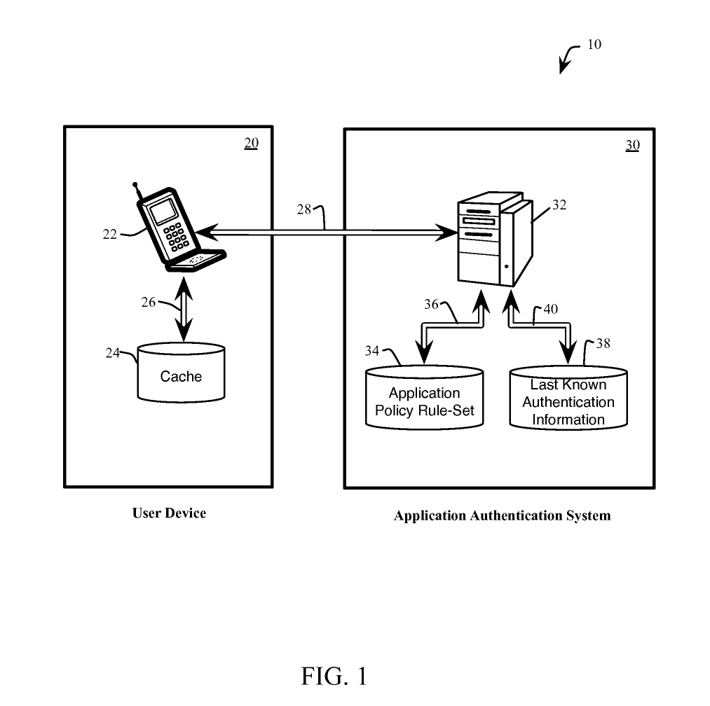

FIG. 1 shows an embodiment of an authentication system 10. A user device 20 includes a cell-phone 22 connected to a local cache 24 over a bus 26. A bus 26 is any electrical medium (e.g. a plurality of wires) capable of transporting computer data. In one embodiment, the local cache 24 is part of the local memory (e.g. RAM) of the cell phone 22. In another embodiment, the local cache 24 is a separate expandable memory module used with the cell-phone 22. The user device 20 is connected over a network 28 to an application authentication system 30. In one embodiment the network 28 is a WiFi connection. In another embodiment, the network 28 is a wireless connection (e.g. CDMA, TDMA, GSM, WiMax, LTE or other standard protocols). In another embodiment where the user device 20 is a desktop computer, the network 28 is a wired Ethernet connection. In other embodiments, the user device 20 is a desk top personal computer (PC) or a tablet PC.

The application authentication system 30 includes a processor 32 connected to a data storage unit 34 over a bus 36. The data storage unit 34 includes an Application Policy Rule-Set for each application managed by the authentication system 10. The processor 32 also connects to a data storage unit 38 over a bus 40. The data storage unit 38 includes a Last Known Authentication Information. In one example, the data storage units 34 and 38 are part of the disk drive memories used by the processor 32 for general long-term storage. In a preferred embodiment, the Application Policy Rule-Set 34 is accessed by the processor 32 when a user on a user device 20 first requests access to an application. The Last Known Authentication Information 38 is accessed when the user on the user device 20 requests access to the application and periodically thereafter depending on the rules defined in the Application Policy Rule-set 34.

In another embodiment, at least one of the Application Policy Rule-Set 34 and the Last Known Authentication Information 38 are stored in the local cache 24 of the user device 20, thereby enabling off-line authentication verification when the user device 20 is not connected to the Application Authentication System 30. In a preferred embodiment, at least one of the Application Policy Rule-set 34 and the Last Known Authentication Information 38 is encrypted, for example with a Pretty Good Privacy (PGP) encryption.

When the user on the user device 20 attempts to access an application, the application either being on the user device 20 or the application authentication system 30, the need for an initial authentication or a new authentication is determined by the application authentication system 30. The application authentication system 30 uses the rules defined for the particular application whose access is being attempted, the rules being contained in the Application Policy Rule-Set 34. The application authentication system 30 compares these rules against the Last Known Authentication Information 38 stored for the application of interest to determine if the recent history of attempts by a particular user on a particular device to access the application of interest should require authentication.

In a preferred embodiment, the need to reauthenticate is based on a timeout, either due to inactivity or is based on time since last authentication. An inactivity based timeout is due to lack of application activity, lack of user activity on the user device 20 or both, depending on the security rules defined in the Application Policy Rule-Set 34. Even with frequent activity from the application or user, a need to reauthenticate can be triggered if too much time has elapsed since the last authentication. In one example, the user on the device is either granted access to the application, the user is required to authenticate or the application is locked due to inactivity. In another embodiment, the user on the user device 20 is granted access to the application requested by the user based on a previous authentication for the same user and same device accessing another application.

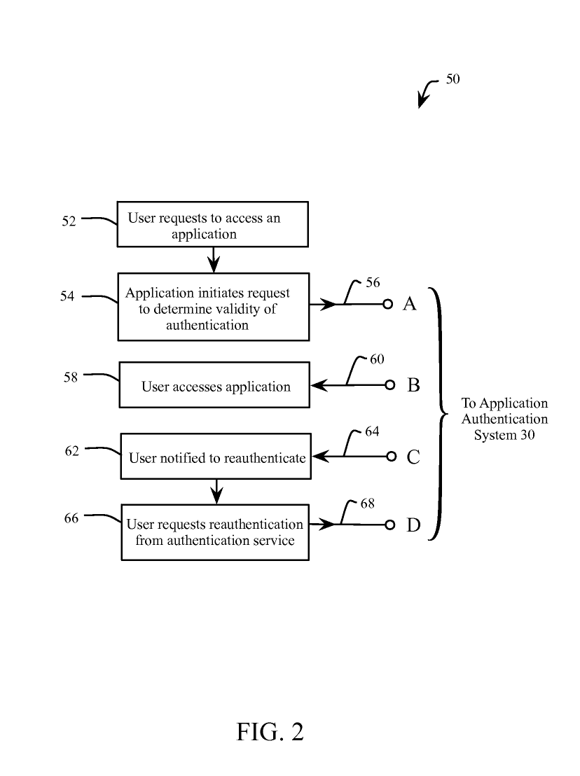

FIG. 2 shows the steps performed by a user on the user device 20 to authenticate access to an application. At step 52, the user requests to access an application. The application is preferentially on the user device 20 but in other embodiments, it is remote to the user device 20, (e.g. on the Application Authentication System 30). At step 54, the application initiates a request to the Application Authentication System 30 to determine the validity of the authentication (e.g. to determine whether an new authentication is required based on parameters such as elapsed time since a last activity, elapsed time since a last authentication, or a valid authentication from another application). The request to validate the authentication is made by a communication 56.

After the Application Authentication System 30 has determined the validity of the authentication request, either step 58 or step 62 will be performed. If the authentication request is determined to be valid, then the user accesses the application at step 58 after being granted access by a communication 60. If the authentication request is determined to be invalid or false, then the user is notified to repeat the authentication at step 62 by a communication 64. The user then requests from an authentication service an authentication at step 66 and sends authentication credentials to the authentication service for authentication. The validity of the authentication is then retested by the Application Authentication System 30 by a communication 68. In a preferred embodiment, the request for authentication verification includes transmitting a user identification, a device identification and an application identification to the Application Authentication System 30 to track and check the validity of the authentication.

In a preferred embodiment, the authentication credentials sent to the authentication service include at least one of a user identification, a password, a country code (e.g. US, UK and BR), a site identification (for a specific store, club or distribution center), a site type (identifying the type of site (e.g. store, club and distribution center), and a domain name. The credentials are forwarded to the authentication service to enable authentication but are not necessary to verify the validity of the authentication. The authentication service (or authentication endpoint) is performed in the application in one example, and in a separate system in another example.

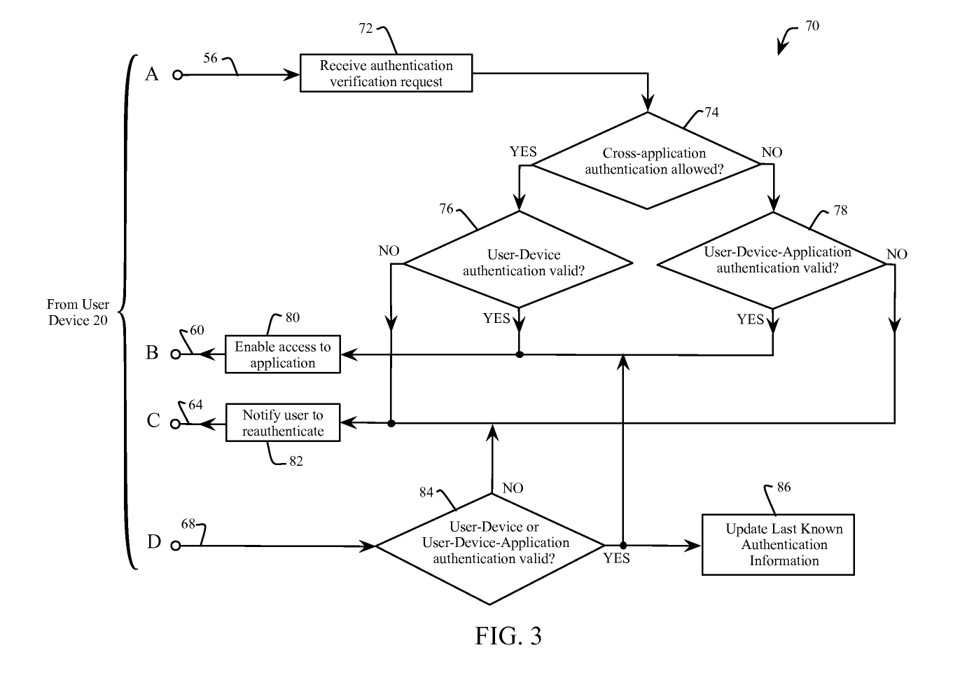

FIG. 3 shows the steps performed by the Application Authentication System 30 to authenticate access to an application. At step 72, a request is received from a user on a user device 20 to authenticate access to an application. As shown in FIG. 1, the Application Authentication System 30 has access to an Application Policy Rule-Set 34 to determine the rules for authentication and to a Last Known Authentication Information 38 to determine previous activity from the application. Access to the Application Policy Rule-Set 34 and the Last Known Authentication Information 38 is continuous in one embodiment; in another embodiment, access occurs only when an authentication request is received at step 72.

At step 74, the Application Authentication System 30 determines if cross-application authentication is allowed. Cross-application authentication means that a previous authentication for another application is used to grant access to a present application. In a preferred embodiment, the cross-application authentication is granted for the same user on the same device for a related application with similar security levels. In one example, two or more social media applications are similar, but an application to access bank records is not granted based on a previous authentication to access a social media website. In another example, the same user accessing the same application on a relatively secure desktop computer is not granted access on a cell phone without a new authentication. If cross-application authentication is allowed, as defined in the Application Policy Rule-Set 34 for the particular application for which access is sought, then the combination of user and device is authenticated at step 76. Otherwise, the combination of user, device and application is authenticated at step 78.

At step 76, the authentication is valid if the same combination of user and user device 20 used to authenticate a previous application is used for the current authentication request. In one example, the previous authentication of any previous application will suffice to allow authentication of the combination of user and device alone. In another example, cross-application authentication is allowed only between certain applications that share a common characteristic, such as security level, defined in the Application Policy Rule-Set 34. As a further example, cross-application authentication is allowed between certain applications that meet a certain minimum security level. At step 78, the authentication is valid if the combination of user, device and application has been previously authenticated and meets certain tests defined in the Application Policy Rule-Set 34. For example, the previous authentication must be recent.

If the authentication request is valid or true (e.g. a new authentication is not required) at step 76 or step 78, the user is enabled to access the application at step 80. If the authentication request is not valid or false, the user is notified to request a new authentication (e.g. reauthenticate) at step 82. After the user has requested a new authentication at step 66 in FIG. 2, the authentication is retested at step 84. Step 84 proceeds in the similar manner to step 74, step 76 and step 78, in that the test for cross-authentication is performed. If the user and device combination is valid when cross-application authentication is allowed, or otherwise if the user, device and application combination is not valid, the user is notified to request a new authenticate at step 64. Otherwise, the user is enabled to access the application at step 80 and the Last Known Authentication Information 38 is updated with at least the current authentication time.

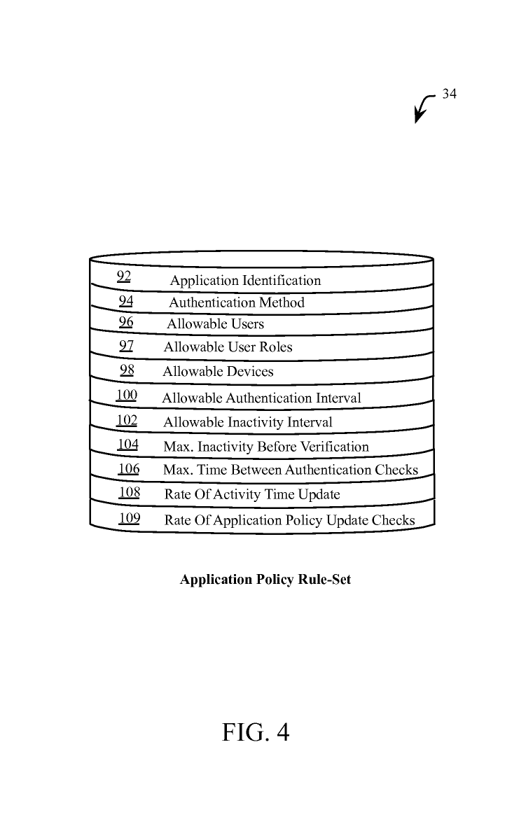

FIG. 4 shows the contents of an Application Policy Rule-Set 34 for a preferred embodiment. Other embodiments are envisioned with either a subset of the information shown in FIG. 4 or other variations directed towards facilitating authentication across multiple applications. Within each Application Policy Rule-Set 34 are groups of rules for each application that has a policy.

The Application Policy Rule-Set 34 includes an Application Identification 92, which is a unique identifier for the application being authenticated. An Authentication Method 94 describes how the authentication is performed. For example, the Authentication Method 94 defines whether cross-application authentication is allowed. Cross-application authentication enables a user to authenticate on any application rather than just the one being accessed. In another embodiment, cross-application authentication is confined to a group of applications with a similar security level, or alternatively to a group of applications that meet a minimum security level. In another embodiment, the cross-application authentication also defines whether the user needs to be active within the current application to reset an inactivity timer or whether activity in any application on the device will suffice.

A list of Allowable Users 96 is defined for each application. In another embodiment, the list of Allowable users 96 is also defined for each user device 20. A list of Allowable User Roles 97 defines groups of users with similar security levels. In one example, sales clerks are one group and district managers are another group. A list of Allowable Devices 98 is defined for each application. An Allowable Authentication Interval 100 defines the allowable time since a previous authentication before a new authentication is required. An Allowable Inactivity Interval 102 defines the allowable time since a previous activity on the user device 20 before a new authentication is required. An activity means any access to the application from the user.

A Maximum Inactivity Before Verification 104 is the amount of time that can pass before activity from the user, the application or both is verified. The Maximum Inactivity Before Verification 104 is less than the Allowable Inactivity Interval 102. In one embodiment, when the application runs on the user device 20, the Application Authentication System 30 must connect with the User Device 20 to determine the activity between the user and the application, by querying the Cache 24. The Cache 24 stores the most recent activity between the user and the application. In another embodiment, the user device 20 sends the time of the most recent activity between the user and the application to the Last Known Authentication Information 38 data storage unit. A Maximum Time Between Authentication Checks 106 determines the time that can pass before the application checks whether there has been a recent authentication. In one example, if the Allowable Authentication Interval 100 is thirty minutes, the Maximum Time Between Authentication Checks 106 is five minutes. A Rate Of Activity Time Update 108 determines how often the Last Known Authentication Information 38 data storage unit is updated with the time that activity occurs between the user and the application. A Rate Of Application Policy Update Checks 109 determines how often the Application Authentication System 30 should check the Application Policy Rule-Set 34 for changes to the rules defined therein.

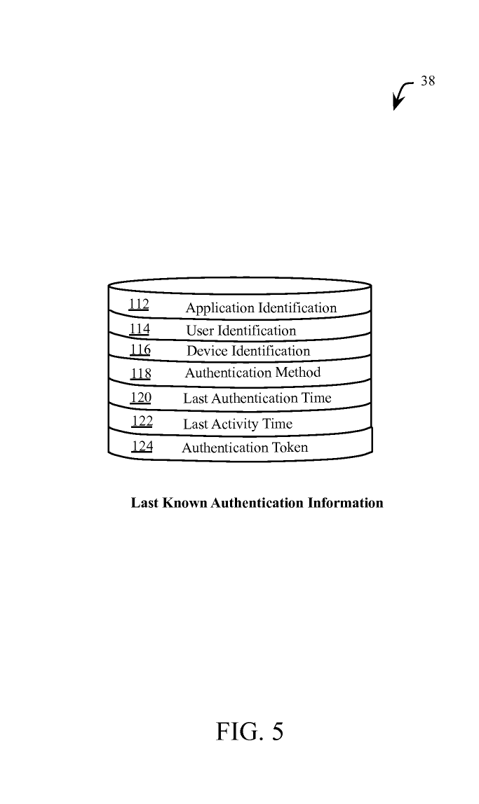

FIG. 5 shows the contents of a Last Known Authentication Information 38 for a preferred embodiment. Other embodiments are envisioned with either a subset of the information shown in FIG. 5 or other variations directed towards facilitating authentication across multiple applications. Within each Last Known Authentication Information 38 are groups of information for each application being authenticated. An Application Identification 112 is a unique identifier for the application being authenticated. A User Identification 114 defines the user (or alternatively a group of users) that accessed the application identified by the Application Identification 112. A Device Identification 116 defines the user device 20 (or alternatively a group of devices) that were used to access the application identified by the Application Identification 112. The Application Method 118 identifies the method used to perform authentication from the various methods defined in the Authentication Method 94 in the Application Policy Rule-Set 34. The Last Authentication Time 120 is the last time a successful authentication was performed. When cross-application authentication is allowed, the Last Authentication Time 120 is the time of authentication with the user and the user device 20, otherwise it is the time of authentication with the application, the user and the user device 20. The Last Activity Time 122 is the time of the last activity between the user and the application, the user and the device, or from the application depending on the application policy defined in the Application Policy Rule-Set 34. Optionally, an Authentication Token 124 is also stored in the Last Known Authentication Information 38 at the time of the previously valid authentication.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method for authentication checking comprising:
receiving an authentication verification request for accessing an application, the authentication verification request including a user identification, a device identification and an application identification;
determining a validity of the authentication verification request, based on at least a last known authentication information, and a first subset of an application policy rule-set specific to the user identification and the device identification, if the application policy rule-set permits cross-application authentication;
determining the validity of the authentication verification request, based on at least the last known authentication information, and a second subset of the application policy rule-set specific to the user identification, the device identification and the application identification, if the application policy rule-set does not permit cross-application authentication;
enabling access to the application if the validity of the authentication verification request is true; and
requesting a new authentication if the validity of the authentication verification request is false.

2. The method of claim 1 wherein determining the validity of the authentication verification request comprises comparing an elapsed time since a last authentication contained in the last known authentication information to an allowable authentication interval contained in the application policy rule-set.

3. The method of claim 1 wherein determining the validity of the authentication verification request comprises comparing an elapsed time since a last activity contained in the last known authentication information to an allowable inactivity interval contained in the application policy rule-set.

4. The method of claim 3 further comprising locking the application when the validity of the authentication verification request is false.

5. The method of claim 1 wherein the application policy rule-set defines an allowable authentication interval specific to at least one of the user identification, the device identification and the application identification.

6. The method of claim 1 wherein the application policy rule-set defines an allowable inactivity interval specific to at least one of the user identification, the device identification and the application identification.

7. The method of claim 1 wherein determining the validity of the authentication verification request comprises comparing at least one of the user identification to a list of allowable users and a user role against a list of allowable user roles.

8. The method of claim 1 wherein determining the validity of the authentication verification request comprises comparing the device identification to a list of allowable devices.

9. The method of claim 1 wherein determining the validity of the authentication verification request comprises comparing the user identification to a list of allowable users for a device defined by the device identification.

10. The method of claim 1 wherein determining the validity of the authentication verification request comprises comparing the user identification to a list of allowable users for a device defined by the device identification and an application defined by the applications identification when the application policy rule-set does not permit cross-application authentication.

11. The method of claim 1 further comprising retrieving the application policy rule-set from a data storage unit over a networked connection.

12. The method of claim 1 further comprising retrieving the application policy rule-set from a local cache on a device defined by the device identification, the local cache including at least a portion of remote data stored in a data storage unit over a networked connection.

13. The method of claim 12 wherein the application policy rule-set is encrypted while stored in the local cache.

14. The method of claim 1 wherein a local cache stores the application policy rule-set, and at least one of a last authentication time and a last activity time.

15. The method of claim 14 wherein the local cache transfers the application policy rule-set, and at least one of the last authentication time and the last activity time to a data storage unit upon reestablishing a network connection between the local cache and the storage unit.

16. The method of claim 1 wherein requesting the new authentication further comprises updating the last known authentication information when a new validity of the new authentication is true.

17. The method of claim 16 wherein updating the data storage unit includes updating at least one of a first elapsed time since a last authentication, a second elapsed time since a last activity, the user identification, the device identification and the application identification.

18. The method of claim 1 further comprising requesting the new authentication if at least one of a maximum time between authentication checks has elapsed and a maximum inactivity before verification has elapsed.

19. A method for accessing an application on a device comprising:
initiating an authentication verification request for accessing an application, the authentication verification request including a user identification, a device identification and an application identification;
accessing the application if the user identification and the device identification are valid, a user authentication is valid and if cross-application authentication is allowed; and
accessing the application if the user identification and the device identification are valid for the application identified by the application identification, the user authentication is valid and if cross-application authentication is not allowed.

20. A computer program product for authentication checking, the computer program product comprising:
a non-transitory computer readable storage medium having computer readable program code embodied therewith, the computer readable program code comprising:
computer readable program code configured to receive an authentication verification request for accessing an application, the authentication verification request including a user identification, a device identification and an application identification;
computer readable program code configured to determine a validity of the authentication verification request, based on at least a last known authentication information, and a first subset of an application policy rule-set specific to the user identification and the device identification, if the application policy rule-set permits cross-application authentication;
computer readable program code configured to determine the validity of the authentication verification request, based on at least the last known authentication information, and a second subset of the application policy rule-set specific to the user identification, the device identification and the application identification, if the application policy rule-set does not permit cross-application authentication;
computer readable program code configured to enable access to the application if the validity of the authentication verification request is true; and
computer readable program code configured to request a new authentication if the validity of the authentication verification request is false.
